(19) United States
(12) Patent Application Publication
(10) Pub. No.: US 2006/0138183 A1
(43) Pub. Date: Jun. 29, 2006

(54) Vehicle Storage Box

(75) Inventors: David A Hein, Sterling Heights, MI (US); Todd DePue, Brighton, MI (US); John P Slaven, Saginaw, MI (US); Michael P. Schoemann, Waterford, MI (US); Doug Lyons, Southfield, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/276,153

(22) Filed: Feb. 16, 2006

Related U.S. Application Data
(63) Continuation-in-part of application No. 10/439,714, filed on May 16, 2003.

(51) Int. Cl. B60R 7/00; B65D 6/12; B65D 73/00

(52) U.S. Cl. 224/282; 206/494; 220/6

(57) ABSTRACT

A foldable sheet for making a storage box for a vehicle. The foldable sheet has multiple portions foldably connected together along at least one fold line. The portions are foldable to at least a partially define a storage box. A hinge may be configured to allow the storage box to pivot with respect to the vehicle.

### CROSS-REFERENCE TO RELATED APPLICATIONS

This application is a continuation-in-part of U.S. application Ser. No. 10/439,714 filed May 16, 2003.

### BACKGROUND OF THE INVENTION

1. Field of the Invention

The present invention relates to a foldable sheet for making a vehicle storage box and a method for making a storage box for mounting in a vehicle.

### SUMMARY OF THE INVENTION

In at least one embodiment of the present invention, a foldable sheet for making a vehicle storage box is provided. The foldable sheet includes multiple portions foldably connected together along at least one fold line. Each of the portions is foldable along the at least one fold line to at least partially define a storage box body having a compartment and an opening that provides access to the compartment. At least one of the portions is a hinge member portion that is disposed opposite the opening and includes a plurality of mounting holes and a hinge portion that is disposed between the plurality of mounting holes and the at least one fold line.

In at least one other embodiment of the present invention, a storage box for mounting in a vehicle is provided. The storage box includes multiple portions that are foldably connected together along at least one fold line. The portions are folded along the at least one fold line such that the portions at least partially define a storage box body and a hinge member disposed adjacent to the storage box body. The hinge member has a hinge defined by first and second hinge portions disposed generally parallel and adjacent to each other that permit the storage box body to pivot with respect to at least a portion of the hinge member.

According to another aspect of the invention, a method for making a storage box for mounting in a vehicle is provided. The method includes forming a foldable member having multiple portions connected together along at least one fold line. The method further includes folding the portions along the at least one fold line such that the portions at least partially define a storage box body that is configured to be mounted in the vehicle.

### BRIEF DESCRIPTION OF THE DRAWINGS

FIGS. 1a-1c are perspective views of a foldable sheet for making a storage box;

FIG. 2 is a perspective view of the storage box made from the foldable sheet;

FIG. 3 is a cross-section of the storage box along line A-A;

FIG. 4 is a section view of a mold for making the foldable sheet, the mold including a forming tool and a blade tool which are shown in retracted positions;

FIG. 5 is a section view of the mold showing the forming tool and the blade tool in advanced positions; and

FIG. 6 is a section view of the mold showing the forming tool in the retracted position and the blade tool in the advanced position.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

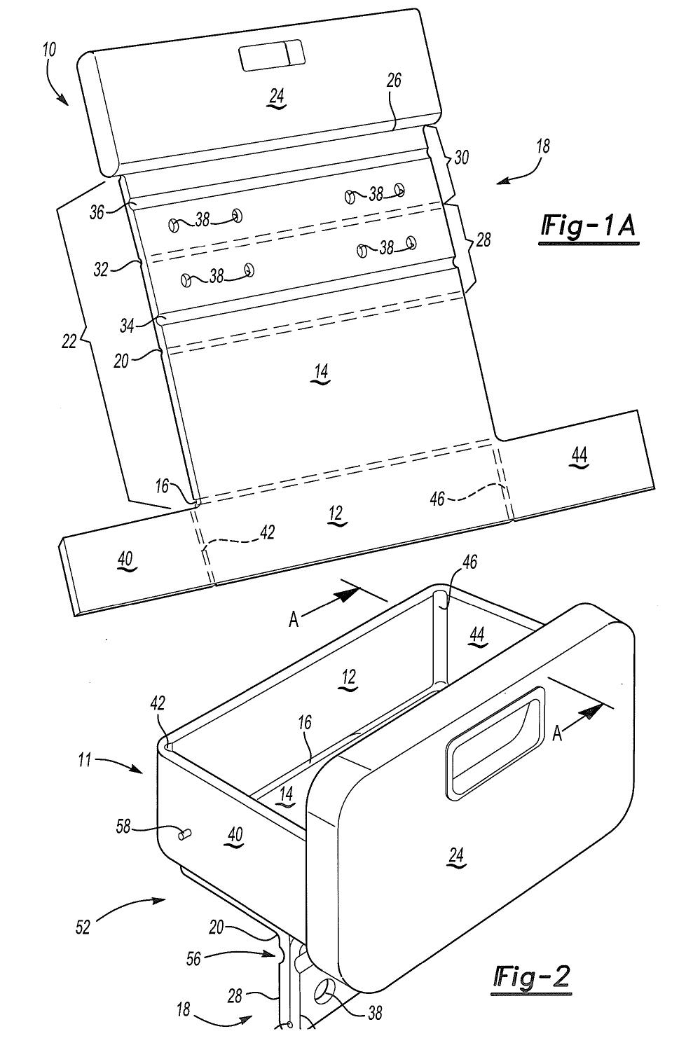

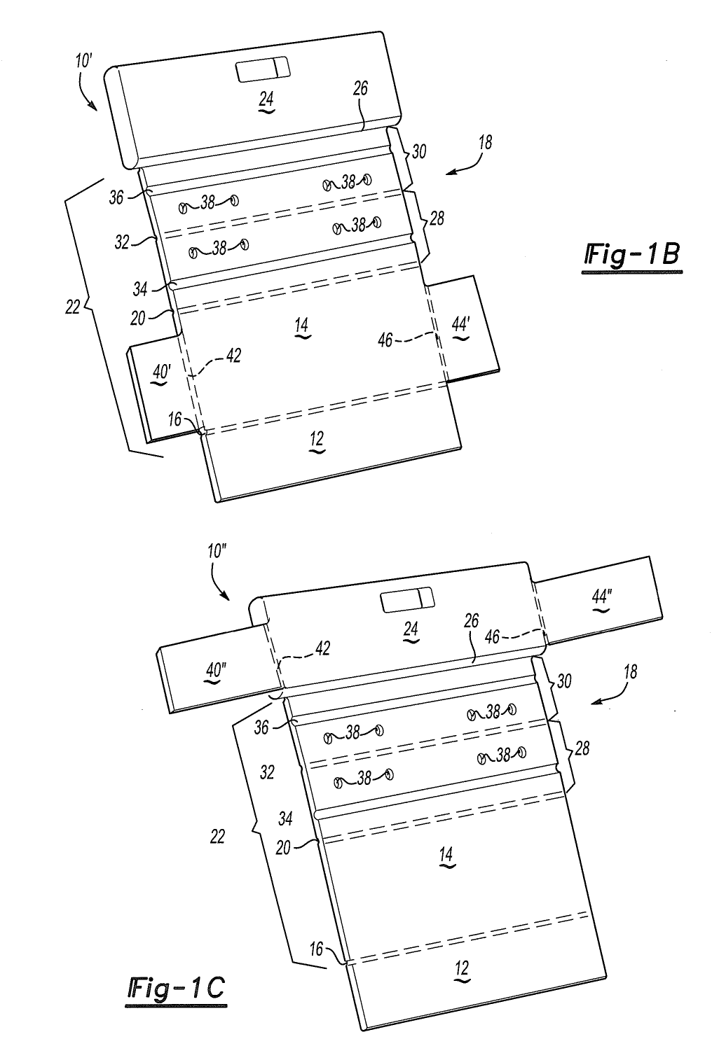

FIG. 1a shows a foldable member, such as foldable sheet 10 according to the invention. The foldable sheet 10 is configured to at least partially define a vehicle storage box, such as a glove box 11 shown in FIG. 2, that is mountable in a vehicle. More specifically, foldable sheet 10 includes multiple portions that are foldably connected together along at least one fold line, such that the portions are foldable to at least partially define the glove box 11.

In the embodiment shown in FIG. 1a, for example, the foldable sheet 10 includes a first portion 12 that defines a back panel of the glove box 11. The first portion 12 is foldably connected to a second portion 14 along a first fold line 16, and the second portion 14 is configured to define a bottom panel of the glove box 11. A third portion 18, also called hinge member or hinge member portion, is foldably connected to the second portion 14 along a second fold line 20. The second portion 14 and the third portion 18 define a bottom panel arrangement 22. The bottom panel arrangement 22 is foldably connected to a fourth portion 24, or front panel, along a third fold line 26. The fourth portion 24 or front panel may include an indentation or handle that extends at least partially into the fourth portion 24

The third portion 18 includes a first section 28 and a second section 30. The first section 28 and the second section 30 are foldably connected along a hinge member fold line 32. The first section 28 includes a first hinge portion 34, and the second section 30 includes a second hinge portion 36. The first hinge portion 34 and the second hinge portion 36 cooperate to define a hinge when the first section 28 and the second section 30 are folded together and exist independently of the hinge before any of the sections of the foldable sheet are folded together. The first section 28 and the second section 30 also include holes 38 that may be drilled, punched, or molded into the foldable sheet 10.

The foldable sheet 10 may also include a fifth portion 40 foldably connected to the first portion 12 along a fourth fold line 42, and a sixth portion 44 foldably connected to the first portion 12 along a fifth fold line 46. The fifth and sixth portions 40 and 44, respectively, may be configured to define first and second side panels, respectively, of the glove box 11.

Alternatively, the foldable sheet 10 (designated 10′ and 10″ in FIGS. 1b and 1c) may have any suitable configuration for at least partially forming the glove box 11. For example, the fifth portion 40 and the sixth portion 44 may each be foldably connected to the first portion 12 as shown in FIG. 1a, the second portion 14 as shown in FIG. 1b (in which the fifth and sixth portions are labeled 40′ and 44′), or the fourth portion 24 as shown in FIG. 1c (in which the fifth and sixth portions are labeled 40″ and 44″). Also, the first portion 12, the bottom panel arrangement 22, and the fourth portion 24 do not need to be foldably connected to each other. Instead, the first portion 12, the bottom panel arrangement 22, and the fourth portion 24 may be foldably connected via the fifth portion 40 or the sixth portion 44. For example, the fifth portion 40 may be foldably connected to the first portion 12 and the bottom panel arrangement 22 without the first portion 12 and the bottom panel arrangement 22 being foldably connected to each other along the first fold line 16. Similar arrangements are possible using the sixth portion 44 instead of the fifth portion 40. Likewise, the bottom panel arrangement 22 may be foldably connected to the fourth portion 24 via the fifth portion 40 or sixth portion 44 rather than by the third fold line 26. Furthermore, one or more of the portions 12, 14, 18, 24, 40 and 44 may be deleted if not required for a particular application. Still further, the foldable sheet 10 may be used to at least partially form any suitable vehicle storage box or compartment, such as a floor or overhead console, that is mountable to a vehicle.

In any embodiment of the present invention, the fold lines that foldably connect the portions together may be configured as indentations or perforations that extend from a common side of the foldable sheet 10. In addition, the fold lines may be extend or be disposed on an opposite side of the foldable sheet 10 than the hinge portions 34,36.

Referring to FIG. 2, a glove box 11 made from the foldable sheet 10 of FIG. 1a is shown. The glove box 11 is assembled by folding and joining together various portions of the foldable sheet 10. The foldable sheet may be folded by hand or it may be fixtured and folded by automated equipment. The first portion 12 is folded perpendicular to the second portion 14 along the first fold line 16. The second portion 14 is folded perpendicular to the first section 28 along the second fold line 20. The first section 28 and the second section 30 of the third portion 18 are folded along the hinge member fold line 32 to be parallel and adjacent to each other. The fourth portion 24 is folded along the third fold line 26 such that the fourth portion 24 is parallel to the second section 30. The fifth portion 40 and sixth portion 44 are folded perpendicular to the first portion 12 such that they are adjacent to the second portion 14 and the fourth portion 24. The fifth portion 40 and/or the sixth portion 44 may be attached to the fourth portion 24 using adhesives, fasteners, snap tabs, insert molded tabs, or a tongue and groove assembly. For example, the fourth portion 24 may be formed with at least one groove to receive a tongue of the fifth portion 40 or the sixth portion 44. Adhesives may be used to glue the tongue and groove together. Alternatively, or supplementary, the fifth portion 40 and/or sixth portion 44 may be attached to the second portion 14.

When folded, the glove box 11 includes a storage box body 52 positioned above the hinge member 18. The storage box body 52 is defined by the first, second, fourth, fifth, and sixth portions 12, 14, 24, 40 and 44, respectively, of the foldable sheet 10. The storage box body 52 defines a compartment or cavity that may receive and hold objects. Access to the compartment may be provided via an opening or open side. In the embodiment shown in FIG. 2, the opening is disposed opposite the bottom panel arrangement 22 and is generally defined by the ends or edges of the first, fourth, fifth, and sixth portions 12,24,40,44.

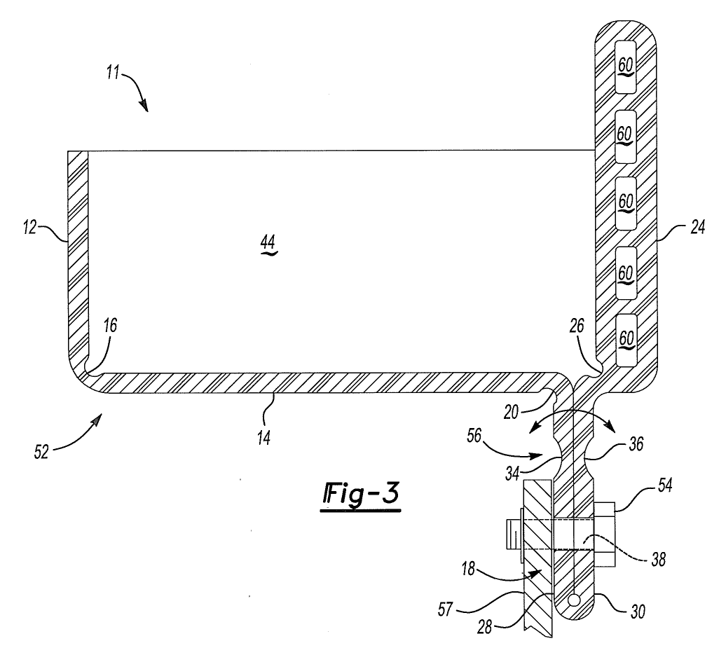

Referring to FIG. 3, a cross-section of the glove box 11 taken along section line A-A of FIG. 2 is shown. A hinge 56 is formed by the first hinge portion 34 and the second hinge portion 36. The hinge 56 may be located along any area of the hinge member 18 above the holes 38. The holes 38 in the first section 28 and the second section 30 align with each other to provide through holes that can be used to attach the hinge member 18 to a mating surface of a vehicle component. For example, bolts or screws may be inserted through the holes 38 to fixedly attach the hinge member 18 to an instrument panel or other interior vehicle component. When attached, the portion of the hinge member 18 below the hinge 56 remains stationary with respect to the mating surface. The hinge 56 allows the storage box body 52 to pivot with respect to the vehicle as shown by the curved arrow.

Referring to FIG. 2, the fifth portion 40 and/or the sixth portion 44 may include a pivot stop 58. The pivot stop or stops may engage another component, such as an instrument panel or housing to prevent the storage box body 52 from pivoting beyond a predetermined point.

Returning to FIG. 3, the fourth portion 24 may include multiple hollow chambers 60 that are configured to manage energy when impacted. For example, in the case of a glove box, the hollow chambers 60 may absorb energy when impacted by the knees of an occupant during a frontal crash.

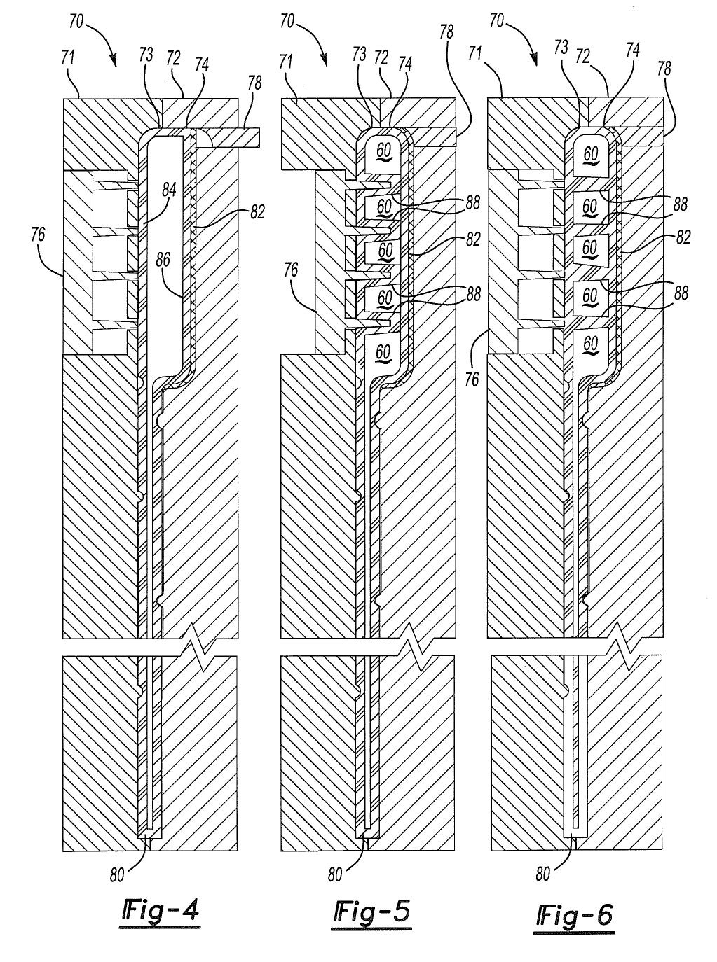

Referring to FIGS. 4-6, a method for making the foldable sheet 10 will now be described. In one embodiment, the foldable sheet 10 may be made using a blow molding process. However, the foldable sheet 10 may be made by any suitable manufacturing process including injection molding and compression molding.

Referring to FIG. 4, for example, a mold 70 is shown having first and second mold portions 71 and 72, respectively, that define first and second cavities 73 and 74, respectively. The first mold portion 71 includes a forming tool 76 that is moveable between a retracted position, shown in FIG. 4, and an advanced position, shown in FIG. 5. The second mold portion 72 includes a blade tool 78 is movable between a retracted position, shown in FIG. 4, and an advanced position, shown in FIGS. 5 and 6.

A parison 80 made of a polymeric material, such as polypropylene, is first inserted into the mold 70. The mold 70 is then closed by bringing the first mold portion 71 and the second mold portion 72 into contact with each other. Next, the parison 80 is expanded to contact the mold 70 and create the foldable sheet 10 using blow molding techniques.

Optionally, a cover layer 82 may be provided over a portion of the foldable sheet 10. The cover layer 82 may be a polymeric material, such as a thermoplastic elastomer or thermoplastic olefin, or any other suitable material that may provide color or texturing if such features are not provided on the underlying foldable sheet. The cover layer 82 may be microperforated to prevent air bubbles from forming between the cover layer 82 and the parison 80 when the parison 80 is expanded against the cover layer 82. In one embodiment, the cover layer 82 may be a sheet that is positioned in the mold 70 before the parison 80 is inserted and expanded. The cover layer 82 may be retained to the mold 70 by fasteners (not shown) or vacuumed to the surface of the mold 70. In another embodiment, the cover layer 82 may be co-extruded into the mold 70 with the parison 80. The cover layer 82 can also be molded to cover surfaces that contact mating components and provide a cushioning effect.

Referring to FIG. 5, hollow chambers 60 are formed by advancing the forming tool 76 into the parison 80. Specifically, the forming tool 76 pushes a first surface 84 into contact with a second surface 86 to form hollow chambers 60 separated by ribs 88. In addition, the blade tool 78 is advanced to form and/or cut a portion of the cover layer 82 and provide a smooth edge. The blade tool 78 remains advanced throughout the remainder of the blow molding process.

Referring to FIG. 6, the forming tool 76 is shown in the retracted position. In the embodiment shown in FIG. 6, the forming tool 76 is retracted to be flush with the surface of the first mold portion 71 that defines the first cavity 73 to provide a smooth surface. The voids formed when the forming tool 76 is retracted are filled by the blow molding process. Specifically, positive pressure provided in the hollow chambers 60 forces adjacent rib walls together such that each rib 88 is formed with a fused double-wall structure.

Secondary operations may be performed after the foldable sheet 10 is molded. Such operations may include trimming flash material, or offal, from the foldable sheet 10, drilling holes, flame treating, and/or painting.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A foldable sheet for making a storage box for a vehicle, the foldable sheet comprising:
multiple portions foldably connected together along at least one fold line;
wherein each of the portions is foldable along the at least one fold line to at least partially define a storage box body having a compartment and an opening that provides access to the compartment, and wherein at least one of the portions is a hinge member portion that is disposed opposite the opening and includes a plurality of mounting holes and a hinge portion that is disposed between the plurality of mounting holes and the at least one fold line.

2. The foldable sheet of claim 1 further comprising a bottom panel arrangement that includes a first portion and the hinge member portion that are foldably connected together along an additional fold line, and wherein the first portion and hinge member portion are foldable along the additional fold line such that the first portion defines a bottom panel of the storage box body and the hinge member portion having a hinge that is configured to allow the storage box body to pivot with respect to at least a portion of the hinge member portion.

3. The foldable sheet of claim 2 wherein the hinge member portion includes a first and second sections foldably connected together along a hinge member fold line, the first and second sections each having a hinge portion, wherein the hinge portions cooperate to define a hinge when the first and second sections are folded along the hinge member fold line such that the first and second sections are disposed proximate each other.

4. The foldable sheet of claim 3 wherein each of the fold lines is disposed on a first side of the foldable sheet and each of the hinge portions is disposed on a second side of the foldable sheet disposed opposite the first side.

5. The foldable sheet of claim 1 wherein the at least one fold line includes first, second, and third fold lines, and the multiple portions include a first portion, a second portion foldably connected to the first portion along the first fold line, a third portion foldably connected to the second portion along the second fold line, and a fourth portion foldably connected to the third portion along the third fold line, and wherein the first, second, and fourth portions are configured to define a back panel, a bottom panel, and a front panel, respectively, of the storage box body, and the third panel is configured to define a hinge member connected to the storage box body and including the hinge.

6. The foldable sheet of claim 5 wherein the fourth portion includes a substrate and a cover layer disposed on at least a portion of the substrate.

7. The foldable sheet of claim 5 wherein the fourth portion has at least one hollow chamber.

8. The foldable sheet of claim 5 further comprising a fifth portion connected to the first portion, the second portion, or the fourth portion along a fourth fold line, wherein the fifth portion is foldable along the fourth fold line to define a first side panel of the storage box.

9. The foldable sheet of claim 8 further comprising a sixth portion connected to the first portion, the second portion, or the fourth portion along a fifth fold line, wherein the sixth portion is foldable along the fifth fold line to define a second side panel of the storage box.

10. A storage box for mounting in a vehicle, the storage box comprising:
multiple portions that are foldably connected together along at least one fold line, the portions being folded along the at least one fold line such that the portions at least partially define a storage box body and a hinge member disposed adjacent to the storage box body, the hinge member having a hinge defined by first and second hinge portions that are disposed generally parallel and adjacent to each other and spaced apart from the storage box body and the at least one fold line, wherein the hinge permits the storage box body to pivot with respect to at least a portion of the hinge member.

11. The storage box of claim 10 wherein the hinge member further comprises first and second sections foldably connected along a hinge member fold line, the first section including the first hinge portion and a first hole and the second section including the second hinge portion and a second hole, the first and second holes being aligned with each other, wherein the hinge is disposed between the first and second holes and the storage box body.

12. The storage box of claim 10 wherein the hinge member includes first and second sections that are connected together along a hinge member fold line, each section including a hinge portion, and wherein the first and second sections are folded along the hinge member fold line such that the hinge portions cooperate to define the hinge.

13. The storage box of claim 10 wherein the at least one fold line includes first and second fold lines, and the multiple portions include a back panel, a bottom panel arrangement connected to the back panel along the first fold line, and a front panel connected to the bottom panel arrangement along the second fold line.

14. The storage box of claim 13 wherein the bottom panel arrangement includes a bottom panel, the hinge member being connected to the bottom panel along a third fold line, and wherein the hinge member is folded along the third fold line such that the hinge member extends below the bottom panel, the hinge member including a hinge for allowing a portion of the storage box to pivot.

15. The storage box of claim 13 wherein the front panel includes a substrate and a cover layer is disposed on at least a portion of the substrate.

16. The storage box of claim 13 wherein the front panel has at least one hollow chamber.

17. The storage box of claim 13 wherein the front panel includes a handle.

18. A method for making a storage box for mounting in a vehicle, the method comprising:
forming a foldable member having multiple portions connected together along at least one fold line; and
folding the portions along the at least one fold line such that the portions at least partially define a storage box body, that is configured to be mounted in the vehicle;
wherein one of the portions of the foldable member defines a hinge member, the hinge member including a hinge that is spaced apart from the storage box body and configured to allow the storage box body to pivot with respect to at least a portion of the hinge member.

19. The method of claim 18 wherein the hinge member includes first and second sections that are foldably connected together along a hinge member fold line, each section including a hinge portion, and wherein the method further includes folding the first and second sections along the hinge member fold line such that the hinge portions cooperate to define the hinge.

20. The method of claim 18 wherein the foldable member includes a first portion, a second portion foldably connected to the first portion along a first fold line, and a third portion foldably connected to the second portion along a second fold line, and wherein the step of folding the portions is performed such that the first, second, and third portions define a back panel, a bottom panel arrangement, and a front panel, respectively, of the storage box body.
